(19) United States
(12) Patent Application Publication
(10) Pub. No.: US 2026/0307659 A1
(43) Pub. Date: Oct. 8, 2026

(54) METHOD FOR AUTOMATICALLY CONFIGURING CONTROL UNITS OF A CONTROL SYSTEM AND CONTROL SYSTEM

(71) Applicant: Robert Bosch GmbH, Stuttgart (DE)

(72) Inventors: Herbert Vollert, Vaihingen/Enz (DE); Steffen Benzler, Eberdingen (DE); Xun Yao, Beilstein (DE)

(21) Appl. No.: 19/578,142

(22) Filed: Mar. 25, 2026

(30) Foreign Application Priority Data
Apr. 3, 2025 (DE) 10 2025 113 025.6

(51) Int. Cl. B60W 50/00; B60T 8/00; H04L 67/125

(52) U.S. Cl. CPC B60W 50/00; B60T 8/00; H04L 67/125; B60W 2050/0075

(57) ABSTRACT

A method for automatically configuring control units of a control system, including wheel brake actuators of a braking system for a vehicle. The method includes: transmitting data signals via a plurality of redundant network interfaces to a plurality of control units, each control unit having at least two communication channels for exchanging data with a central control device via redundant network interfaces, wherein each network interface transmits a data signal that is different from the remaining network interfaces; assigning each control unit to a predetermined assembly based on a preconfigured combination of the various data signals that is uniquely assigned to the particular predetermined assembly in connection with the at least two communication channels of each control unit; and loading a configuration for the particular control unit depending on the assignment of the plurality of control units to the particular predetermined assembly.

### CROSS REFERENCE

The present application claims the benefit under 35 U.S.C. § 119 of Germany Patent Application No. DE 10 2025 113 025.6 filed on Apr. 3, 2025, which is expressly incorporated herein by reference in its entirety.

### FIELD

The present disclosure relates to a method for automatically configuring control units of a control system, in particular wheel brake actuators of a braking system for a vehicle, and to a control system, in particular a braking system for a vehicle, with which such a method is executable.

### BACKGROUND INFORMATION

Certain conventional braking systems have at most two control units, wherein the two control units are provided with different software. Braking systems such as electromechanical brakes (EMB) and methods for operating these are likewise conventional. Generally, such braking systems comprise a plurality of wheel brakes, of which, in each case, one is assigned to one of the wheels of a vehicle, so that each wheel can be braked individually. The brake components of the wheel brakes are usually controlled individually by means of a control unit assigned to the wheel brake. In general, control units of the wheel brakes are provided with the same software. Such braking systems usually contain at least one VCU (vehicle control unit) and four wheel brake actuators.

For example, Germany Patent Application No. DE 10 2017 212 256 A1 describes a method for configuring identical network components, wherein the network components are in each case connected via a network cable to a physical port of a network switch. A further network station is likewise connected to the network switch. In the method, configuration messages are sent from the further network station to the network components. The method is characterized in that the configuration message tells the particular network component to which the physical port of the network switch the network component is connected. The network component then performs a reconfiguration corresponding to the connection to the physical port regarding its function in the network.

Furthermore, Germany Patent Application No. DE 10 2015 014 049 A1 describes a method for setting a configuration data set in a control unit of a motor vehicle. The configuration data set is intended to be installed reliably in the control unit. For this purpose, the invention provides that an energy requirement of all vehicle components required for setting the configuration data set is predicted, a currently available residual energy of an energy storage device of the motor vehicle is ascertained, and during a parking phase of the motor vehicle with a drive motor switched off, a trigger signal for setting the configuration data set is transmitted to the vehicle components only if the current residual energy is greater than the predicted energy requirement.

A difficulty of certain conventional braking systems includes that the software in the control units must be individually adapted and must be compatible with one another. In addition, this adaptation is susceptible to errors, in particular if a plurality of identical control units are incorporated into a system.

### SUMMARY

The present disclosure provides a method for automatically configuring control units of a control system, in particular wheel brake actuators of a braking system for a vehicle, and a control system, in particular a braking system for a vehicle,.

According to a first aspect of the present disclosure, a method for automatically configuring control units of a control system, in particular wheel brake actuators of a braking system for a vehicle, is provided. According to an example embodiment, the method comprises the following steps.

Transmitting data signals or assignment signals via a plurality of redundant network interfaces to a plurality of control units, wherein each control unit of the plurality of control units has at least two communication channels for exchanging data with a central control device via the plurality of redundant network interfaces. Each network interface of the plurality of redundant network interfaces transmits a data signal that is different from any of the remaining network interfaces.

Assigning the plurality of control units in each case to a predetermined assembly based on a preconfigured combination of the various data signals that is uniquely assigned to the particular predetermined assembly in connection with the at least two communication channels of each control unit.

Loading a configuration for the particular control unit depending on the assignment of the plurality of control units to the particular predetermined assembly.

According to a second aspect of the present disclosure, a control system, in particular a braking system for a vehicle, is provided. With the control system, a method according to the first aspect of the present disclosure is executable. According to an example embodiment, the control system comprises a central control device with a plurality of redundant network interfaces. Furthermore, the control system comprises a plurality of control units that are electronically coupled to the central control device via the plurality of redundant network interfaces. Each control unit of the plurality of control units has at least two communication channels for exchanging data with the central control device via the plurality of redundant network interfaces.

An idea of the present disclosure includes that an automatic configuration of the control units can be provided depending on networking of the control units with the central control device. This means the control system contains two different software, wherein a first software is installed in a plurality of similarly constructed control units. This control system can configure itself based on unique features that arrive via a network communication, i.e., the preconfigured combination. In this case, it is irrelevant which type of communication network is used.

A central unit or the central control device can send a specific pattern, i.e., the data signals, on the redundant networks or network interfaces. An architecture of the networks is selected so that each control unit can ascertain, based on the data or the data signals in connection with the communication channels of the control unit, to which predetermined assembly this control unit is assigned. By means of the preconfigured combination of a configuration step and suitable networking, each control unit can ascertain to which predetermined assembly this control unit is assigned.

The plurality of control units can in each case be configured for executing the first software. For example, each control unit can have a computing unit for executing the first software and a storage unit assigned to the computing unit. The first software can be stored in the memory unit.

The preconfigured combination of the various data signals combines, for example, a first data signal and a second data signal. The control unit can distinguish whether the first data signal arrives via a first of the at least two communication channels or via a second of the at least two communication channels. Conversely, the second data signal can arrive at the control unit via the second communication channel or via the first communication channel. In this way, a first control unit in which the first data signal arrives via the first communication channel and the second data signal arrives via the second communication channel can be uniquely distinguished from a second control unit in which the first data signal arrives via the second communication channel and the second data signal arrives via the first communication channel.

An advantage of the present disclosure is that an assignment of the plurality of control units to the particular predetermined assembly can be executed without additional steps and/or hardware adaptations being necessary. The method according to the present disclosure can therefore use existing redundant networks to assign the control units coupled thereto.

Advantageous example embodiments and developments can be found in the disclosure herein.

According to a development of the present disclosure, the plurality of control units are assigned to the particular predetermined assembly on the basis of the respectively received data signals and depending on the at least two communication channels.

According to a further development of the present disclosure, a network interface of the plurality of redundant network interfaces exchanges data with each control unit. Thus, the central control device can communicate with all control units via the one network interface in a simple manner. In addition, the number of redundant network interfaces can thereby be reduced to a minimum for a given number of communication channels.

According to a further development of the present disclosure, the assigning of the plurality of control units is stored on a non-volatile storage medium of each control unit. Thus, each control unit can remember to which predetermined assembly it is assigned, so that the assignment can also be used for further software adaptations. The non-volatile storage medium can correspond to the storage unit of the control unit.

According to a further development of the present disclosure, the central control device triggers the transmission of the data signals. The central control device can be configured to execute a second software that is different from the first software. The second software is in its regular operating mode, meaning it is already configured.

According to a further development of the present disclosure, the method further comprises the step of determining invalid communication data of the plurality of control units by the central control device before the data signals are transmitted. In this way, the plurality of control units can configure themselves fully automatically at the first start-up of the control system, in particular of a distributed braking system. In this step, it is therefore recognized that no valid communication data are received from the receiving control units.

According to a further development of the present disclosure, the data signals are transmitted via three redundant network interfaces to four control units, wherein the four control units in each case have two communication channels, so that the preconfigured combination provides at least four mutually different unique assignments. Thus, a unique distinguishability of a plurality of control units can be provided with low hardware expenditure.

For example, in a first control unit, the first data signal can arrive via the first communication channel and the second data signal via the second communication channel, wherein, in a second control unit, the first data signal can arrive via the second communication channel and the third data signal via the first communication channel. Furthermore, in a third control unit, the first data signal can arrive via the first communication channel and the third data signal via the second communication channel, wherein, in a fourth control unit, the first data signal can arrive via the second communication channel and the second data signal via the first communication channel. Based on other preconfigured combinations, five or six mutually different unique assignments can also be created.

According to a further development of the present disclosure, with an increasing number of the plurality of control units, a number of the plurality of redundant network interfaces or a number of the communication channels of each control unit or both increases, so that, based on a preconfigured combination of the plurality of redundant network interfaces in connection with the number of communication channels, each control unit can be uniquely assigned.

According to a further development of the present disclosure, the plurality of redundant network interfaces comprises a first, a second and a third network interface, wherein the plurality of control units comprises a first, a second, a third and a fourth control unit, wherein the at least two communication channels comprise a first and a second communication channel, wherein the first control unit is coupled via the first communication channel to the first network interface and via the second communication channel to the second network interface, wherein the second control unit is coupled via the second communication channel to the first network interface and via the first communication channel to the third network interface, wherein the third control unit is coupled via the first communication channel to the first network interface and via the second communication channel to the third network interface, and wherein the fourth control unit is coupled via the second communication channel to the first network interface and via the first communication channel to the second network interface.

The central control device can, for example, be designed as a vehicle control unit. In this case, the central control device can have a single control element or a plurality of control elements. The control unit can, for example, be designed as a wheel brake actuator. In this case, each control unit can interact with or be connected to a particular assembly.

In the following, the subject matter disclosed above is expressed once again and additionally in other words. This concept relates - represented in simplified form - to a method in which the following are combined in a suitable manner:

the number of network interfaces of a central control unit, in particular of the central control device, with the second software. The network interfaces may also be necessary or advantageous for redundancy.

with the physical wiring, in particular the order, and the number of network buses or communication channels at the individual control units that are assigned, for example, to wheel brakes;

and the first software in the control units that assumes only its standard communication if its configuration is completed and waits beforehand for a configuration in order to obtain therefrom unambiguous information as to at which predetermined assembly, in particular at which wheel brake, this one control unit is located.

Thus, the configuration of the control units is fully automatic.

### BRIEF DESCRIPTION OF THE DRAWINGS

The present disclosure is explained below with reference to the figures.

FIG. 1 is a schematic representation of a braking system for a vehicle according to an exemplary embodiment of the present disclosure.

FIG. 2 is a flow diagram of a method for automatically configuring control units of a control system, in particular wheel brake actuators of a braking system for a vehicle, according to a further exemplary embodiment of the present disclosure.

In the figures, identical reference signs denote identical or functionally identical components, unless stated otherwise. The numbering of method steps serves the purpose of clarity and is generally not intended to imply a specific chronological order. In particular, a plurality of method steps may also be carried out simultaneously.

### DETAILED DESCRIPTION OF EXAMPLE EMBODIMENTS

Further advantages, features, and details of the present disclosure will become apparent from the following description, in which various exemplary embodiments are described in detail with reference to the figures.

In the following, the present disclosure is described in relation to an electromechanical braking system; however, it is not limited to this application but can likewise be applied to any other system or product having a plurality of control units.

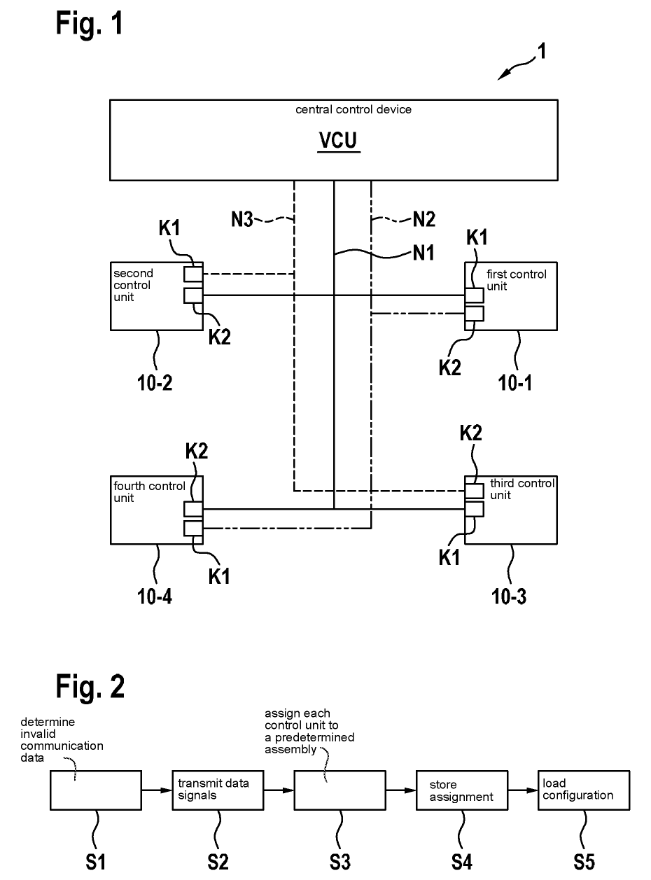

FIG. 1 is a schematic representation of a braking system 1 for a vehicle according to an exemplary embodiment of the present disclosure. For example, the braking system 1 is designed and configured for use in a vehicle. The vehicle can typically contain a front axle and a rear axle.

The braking system 1 comprises a central control device VCU and a plurality of control units 10-i, here by way of example a first 10-1, a second 10-2, a third 10-3 and a fourth control unit 10-4. The central control device VCU has a plurality of redundant network interfaces that comprise, by way of example, a first N1, a second N2 and a third network interface N3. For example, each control unit 10 can have a computing unit (not shown) for executing a first software and a storage unit assigned to the computing unit. The first software can be stored in the memory unit. The central control device VCU can be configured to execute a second software that is different from the first software. The second software is in its regular operating mode, meaning it is already configured.

The four control units 10-1, 10-2, 10-3, 10-4 are electronically coupled to the central control device VCU via the three network interfaces N1, N2, N3, wherein each control unit 10 of the four control units 10-1, 10-2, 10-3, 10-4 has two communication channels K1, K2 for exchanging data with the central control device VCU via the network interfaces N1, N2, N3.

In FIG. 1, the control system 1 comprises, by way of example, the four control units 10-1, 10-2, 10-3, 10-4, the three network interfaces N1, N2, N3 and the two communication channels K1, K2. However, the control system 1 can also contain two or more control units 10-i, two or more network interfaces and at least two communication channels. With an increasing number of the plurality of control units 10-i, a number of the plurality of redundant network interfaces N1, N2, N3 or a number of the communication channels K1, K2 of each control unit 10 or both can increase, so that, based on a preconfigured combination of the plurality of redundant network interfaces N1, N2, N3, each control unit 10 can be uniquely assigned in connection with the number of communication channels K1, K2.

For example, the first control unit 10-1 can be coupled via the first communication channel K1 to the first network interface N1 and via the second communication channel K2 to the second network interface N2. Furthermore, the second control unit 10-2 can be coupled to the first network interface N1 via the second communication channel K2 and to the third network interface N3 via the first communication channel K1. Moreover, the third control unit 10-3 can be coupled via the first communication channel K1 to the first network interface N1 and via the second communication channel K2 to the third network interface N3. Furthermore, the fourth control unit 10-4 can be coupled via the second communication channel K2 to the first network interface N1 and via the first communication channel K1 to the second network interface N2. The networking of the four control units 10-1, 10-2, 10-3, 10-4 with the central control device VCU described above is shown in FIG. 1 by way of example. In particular, the first network interface N1 can be coupled to the four control units 10-1, 10-2, 10-3, 10-4.

The central control device VCU can, for example, be designed as a vehicle control unit. The central control device VCU can have a single control element or a plurality of control elements. The control unit 10 can, for example, be designed as a wheel brake actuator. In this case, each control unit 10 can interact with or be connected to a particular assembly.

The braking system 1 is designed for executing a method for automatically configuring control units of a control system, in particular wheel brake actuators of a braking system for a vehicle. For example, this method is a method with features according to the exemplary embodiment from FIG. 2.

FIG. 2 is a flow diagram of a method for automatically configuring control units of a control system, in particular wheel brake actuators of a braking system for a vehicle, according to a further exemplary embodiment of the invention.

The method comprises, for example, the steps of determining S1, transmitting S2, assigning S3, storing S4 and loading S5.

In the optional step S1, invalid communication data of the plurality of control units 10-i can be determined by the central control device VCU before the data signals are transmitted. In this way, the plurality of control units can configure themselves fully automatically at the first start-up of the control system, in particular of a distributed braking system. In this step S1, it is therefore recognized that no valid communication data are being received from the receiving control units 10.

In step S2, data signals are transmitted via a plurality of redundant network interfaces N1, N2, N3 to a plurality of control units 10-i. Each control unit 10 of the plurality of control units 10-i has at least two communication channels K1, K2 for exchanging data with a central control device VCU via the plurality of redundant network interfaces N1, N2, N3. Each network interface of the plurality of redundant network interfaces N1, N2, N3 transmits a data signal that is different from the remaining network interfaces. The plurality of control units 10-i can in each case be configured for executing a first software. For example, each control unit 10 can have a computing unit for executing the first software and a storage unit assigned to the computing unit. The first software can be stored in the memory unit.

Optionally, the central control device VCU can trigger the transmission of the data signals. The central control device VCU can be configured to execute a second software that is different from the first software. The second software is in its regular operating mode, meaning it is already configured.

For example, a network interface N1 of the plurality of redundant network interfaces N1, N2, N3 can exchange data with each control unit 10.

In step S3, the plurality of control units 10-i are assigned in each case to a predetermined assembly based on a preconfigured combination of the various data signals that is uniquely assigned to the particular predetermined assembly in connection with the at least two communication channels K1, K2 of each control unit 10. The preconfigured combination of the various data signals combines, for example, a first data signal and a second data signal. The control unit 10 can distinguish whether the first data signal arrives via a first K1 of the at least two communication channels or via a second K2 of the at least two communication channels. Conversely, the second data signal can arrive at the control unit 10 via the second communication channel K2 or via the first communication channel K1. In this way, a first control unit 10-1 in which the first data signal arrives via the first communication channel K1 and the second data signal arrives via the second communication channel K2 can be uniquely distinguished from a second control unit 10-2 in which the first data signal arrives via the second communication channel K2 and the second data signal arrives via the first communication channel K1. By way of example, the plurality of control units 10-i can be assigned S3 to the particular predetermined assembly on the basis of the respectively received data signals and depending on the at least two communication channels K1, K2.

Optionally, the data signals can be transmitted via three redundant network interfaces N1, N2, N3 to four control units 10-1, 10-2, 10-3, 10-4, wherein the four control units 10-1, 10-2, 10-3, 10-4 in each case have two communication channels K1, K2, so that the preconfigured combination provides at least four mutually different unique assignments. For example, in a first control unit 10-1, the first data signal can arrive via the first communication channel K1 and the second data signal via the second communication channel K2, wherein, in a second control unit 10-2, the first data signal can arrive via the second communication channel K2 and the third data signal via the first communication channel K1. Furthermore, in a third control unit 10-3, the first data signal can arrive via the first communication channel K1 and the third data signal via the second communication channel K2, wherein, in a fourth control unit 10-4, the first data signal can arrive via the second communication channel K2 and the second data signal via the first communication channel K1. Based on other preconfigured combinations, five or six mutually different unique assignments can also be created.

Furthermore, the assignment S3 of the plurality of control units 10-i can be stored S4 on a non-volatile storage medium of each control unit 10. Thus, each control unit 10 can remember to which predetermined assembly it is assigned, so that the assignment can also be used for further software adaptations. The non-volatile storage medium can correspond to the storage unit of the control unit.

In step S5, a configuration for the particular control unit 10 is loaded depending on the assignment of the plurality of control units 10-i to the particular predetermined assembly.

Although the present invention has been explained above by way of example with reference to exemplary embodiments, it is not limited thereto, but can be modified in many ways. In particular, combinations of the above exemplary embodiments are also conceivable.

What is claimed is:

1. A method for automatically configuring control units of a control system, comprising the following steps:
transmitting data signals via a plurality of redundant network interfaces to a plurality of control units, wherein each control unit of the plurality of control units has at least two communication channels for exchanging data with a central control device via the plurality of redundant network interfaces, wherein each network interface of the plurality of redundant network interfaces transmits a data signal that is different from remaining network interfaces of the network interfaces;
assigning each control unit of the plurality of control units to a respective predetermined assembly based on a preconfigured combination of various ones of the data signals that is uniquely assigned to the respective predetermined assembly in connection with the at least two communication channels of the control unit; and
loading a configuration for a respective control unit of the plurality of control units depending on the assignment of the respective control unit to the respective predetermined assembly.

2. The method according to claim 1, wherein the control units include wheel brake actuators of a braking system for a vehicle.

3. The method according to claim 1, wherein each of the plurality of control units are assigned to the respective predetermined assembly based on respectively received data signals and depending on the at least two communication channels.

4. The method according to claim 1, wherein a network interface of the plurality of redundant network interfaces exchanges data with each control unit of the plurality of control units.

5. The method according to claim 1, wherein the assignment of each control unit of the plurality of control units is stored on a non-volatile storage medium of the control unit.

6. The method according to claim 1, wherein the central control device triggers the transmission of the data signals.

7. The method according to claim 1, further comprising:
determining invalid communication data of the plurality of control units by the central control device before the data signals are transmitted.

8. The method according to claim 1, wherein the data signals are transmitted via three redundant network interfaces to four control units, wherein each of the four control units has two communication channels, so that the preconfigured combination provides at least four mutually different unique assignments.

9. A control system, comprising:
a central control device including a plurality of redundant network interfaces; and
a plurality of control units that are electronically coupled to the central control device via the plurality of redundant network interfaces, wherein each control unit of the plurality of control units has at least two communication channels for exchanging data with the central control device via the plurality of redundant network interfaces;
wherein a method is executable using the control system, the method including the following steps:
transmitting data signals via the plurality of redundant network interfaces to the plurality of control units, wherein each network interface of the plurality of redundant network interfaces transmits a data signal that is different from remaining network interfaces of the network interfaces,
assigning each control unit of the plurality of control units to a respective predetermined assembly based on a preconfigured combination of various ones of the data signals that is uniquely assigned to the respective predetermined assembly in connection with the at least two communication channels of the control unit; and
loading a configuration for a respective control unit of the plurality of control units depending on the assignment of the respective control unit to the respective predetermined assembly.

10. The control system according to claim 9, wherein the control system is a braking system for a vehicle.

11. The control system according to claim 9, wherein, with an increasing number of the plurality of control units, at least one of the following increases: a number of the plurality of redundant network interfaces, or a number of the communication channels of each control unit, so that, based on a preconfigured combination of the plurality of redundant network interfaces, each control unit can be uniquely assigned in connection with the number of communication channels.

12. The control system according to claim 9, wherein the plurality of redundant network interfaces includes a first network interface, a second network interface, and a third network interface, wherein the plurality of control units includes a first control unit, a second control unit, a third control unit, and a fourth control unit, wherein the at least two communication channels of each of the plurality of control units include a first communication channel and a second communication channel, wherein the first control unit is coupled via the first communication channel of the first control unit to the first network interface and via the second communication channel of the first control unit to the second network interface, wherein the second control unit is coupled via the second communication channel of the second control unit to the first network interface and via the first communication channel of the second control unit to the third network interface, wherein the third control unit is coupled via the first communication channel of the third control unit to the first network interface and via the second communication channel of the third control unit to the third network interface, and wherein the fourth control unit is coupled via the second communication channel of the fourth control unit to the first network interface and via the first communication channel of the fourth control unit to the second network interface.
